(19) United States
(12) Patent Application Publication
(10) Pub. No.: US 2008/0066369 A1
(43) Pub. Date: Mar. 20, 2008

(54) FLOAT APPARATUS

(76) Inventor: Richard Walter, Gardnerville, NV (US)

Correspondence Address: MCDERMOTT WILL & EMERY LLP, 28 STATE STREET, BOSTON, MA, 02109-1775, US

(21) Appl. No.: 11/763,582

(22) Filed: Jun. 15, 2007

Related U.S. Application Data
(60) Provisional application No. 60/814,035, filed on Jun. 15, 2006.

(51) Int. Cl. A01K 93/00; A01K 91/08

(52) U.S. Cl. 43/44.9; 43/43.13; 43/44.87

(57) ABSTRACT

Embodiments of the present disclosure are directed to float devices useful for fishing that have flutes or ribs. The ribs can be generally oriented along a portion of the longitudinal axis of the apparatus in exemplary embodiments, though other configurations for the ribs are possible. The fluted ribs can be molded into the body of the float in exemplary embodiments. The fluted ribs can add stability to the float, helping the float track better, improving use in fast moving water, e.g., during trolling. Such fluted ribs can reduce a tendency of the float to spin in fast water. Additionally, bait can be added to the grooves created by the fluted ribs. The fluted ribs can also add volume to the float for a given weight or mass, which can improve the natural drifting of the float to better match the current speed of the surrounding water, mimicking natural bait.

### RELATED APPLICATION

This application claims the benefit of U.S. Provisional Application Ser. No. 60/814,035 filed 15 Jun. 2006, the contents of which are incorporated herein by reference.

### BACKGROUND

Fishing floats are commonly used to position fishing line and/or related fishing gear, such as hooks and lures, at a desired water depth. Certain fishing floats of the prior art are of hollow construction with a partly removable pin so that the float can be partially filled with water to reduce buoyancy. In order to cast a hook and leader further into deeper water, it is the custom to add various lead weights to the fishing line. Other prior art floats require a line spool for releasing predetermined lengths of line after the float hits the water surface since the floats were not designed to submerge to reach deeper water. Such line release floats require resetting of the leader line on a spool prior to each cast.

U.S. Pat. No. 4,477,996, issued 23 Oct. 1984, entitled “Variable Weight Casting Device,” the contents of which are incorporated herein by reference, describes a hollow central bore of varying diameters for retention of a fishing line with a weight selected from weights of different density by which the casting device achieves a range for surface or depth fishing.

Additional prior art floats have employed a thin-walled tubular section through which a fishing line is run. Certain of such prior art floats have include one or more sealed cavities formed by thin-walls within the float, possibly in conjunction with the use of pellets or weights positioned within the cavities for ballast adjustment. Such devices have generally been seen as susceptible to instability in fast moving water. Such devices, furthermore, may not sufficiently mimic natural bait because of, for example, an unnatural presentation or set of movements when entering and traveling through water.

What is desirable therefore is an improved float apparatus providing increased stability in fast moving water. What is further desirable is such a float apparatus that provides a natural presentation, mimicking natural bait.

### SUMMARY

The present disclosure is directed to apparatus that substantially or altogether eliminate the shortcomings, limitations, and disadvantages described previously for the prior art. Embodiments of the present disclosure address the problems noted previously for the prior art by providing a casting device, or float, with flutes or ribs, such as one oriented parallel to the direction of travel of the float, or generally along a portion of the longitudinal axis of the casting device. The fluted ribs can be molded into the body of the float. In operation, the flutes can ad or increase stability to the float, which helps the float track better and improves performance of the float, e.g., when used during trolling. Such flutes can also serve to reduce the tendency of the float to spin in fast moving water.

Additionally, the presence of the ribs provides locations where bait can be added to and held by the float, e.g., in the grooves between the fluted ribs. The grooves between the ribs can hold bait and allow a slow release of the bait scent to attract game fish. The ribs can also add volume to the float for a given weight/mass. The increased volume for a given weight/mass can improve the natural drifting of the float to better match the current speed of the water. The fluted ribs can also provide reduced splash or improved “softness,” which in turn can help in presentation when the float is cast into rocks, etc.

### BRIEF DESCRIPTION OF THE DRAWINGS

Various aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 is a perspective view depicting an embodiment of the present disclosure;

FIG. 2 is an end view depicting a further embodiment of the disclosure; and

FIGS. 3A-3C depicts an end view and parallel cross sectional views of an exemplary embodiment of the present disclosure.

While certain embodiments are shown in the figures, it should be understood by one skilled in the art that the embodiments depicted in the drawings are illustrative and variations of those shown as well as other embodiments described herein may be envisioned and practiced within the scope of the disclosure.

### DETAILED DESCRIPTION

The following description refers to several possible embodiments of the present disclosure. It should be understood by one skilled in the art that variations of the embodiments described herein may be envisioned and practiced within the scope of the disclosure.

Embodiments of the present disclosure are directed to float devices that may be used in conjunction with fishing line to facilitate placement of tackle gear, e.g., a baited hook, at a desired depth relative to the water surface. Such devices may offer functionality of a float and/or a sinker, and may be referred to variously as a float, a casting float, and/or or a drifting sinker. Such devices can also be used with a fishing pole and other devices used for fishing, e.g., casting and trolling equipment.

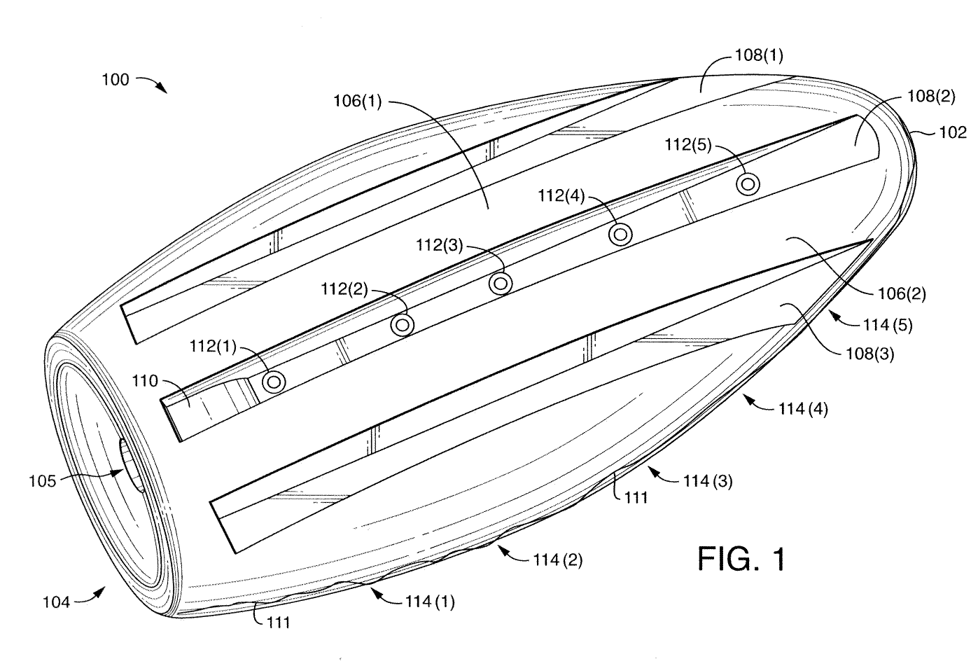

FIG. 1 is a perspective view depicting an embodiment of the present disclosure. A casting float or drifting sinker 100 having a shape similar to a bullet or generally truncated cone with a first end 102 and a second end 104. The float 100 may include a body with a lateral surface including a number of flutes or ribs, e.g., ribs 106(1)-106(2), defined by a number of channels, e.g., 108(1)-108(3). Though not directly shown in FIG. 1, it will be appreciated that corresponding ribs and grooves may optionally be present on the backside of the float 100. The float 100 can include a bore 105 that is suitable for passing a length of fishing line. In exemplary embodiments, float 100 may present an outline or general shape of an ogive or bullet as previously described, though other shapes are suitable.

The ribs 106 may facilitate stability of the float 100 when traveling on or in water. The added stability provided may facilitate (i) tracking of the float 100, for example, as used during trolling, or (ii) reduced tendency for spinning in fast moving water, or a combination of (i) and (ii). The fluted ribs and grooves may be formed by a molding process used for formation of the float body 100, in exemplary embodiments.

The first end 102 of the float may be generally conical in exemplary embodiments and the second end may be flat or generally concave. The first end 102 and second end 104 of the float 100 may have other suitable shapes as well and are not limited to providing an overall bullet-like shape to the float 100. The float 100 may be made of any suitable material, and may be configured in any desired size and shape that includes ribs (or similar structures) and channels. In certain exemplary embodiments, the float 100 may have a length of approximately two inches (5 cm), with an overall weight of approximately 1-3 oz. Certain other exemplary embodiments may be approximately ten times in size and weight, e.g., as used for deep water fishing.

It will be understood that the configuration of the ribs 106 can vary from that depicted in FIG. 1. For example, in certain embodiments, the ribs can include holes or other apertures. The grooves may have an inner radial surface that varies along the length of the float 100, for example, by including one or more ramps 110. The ribs can for further example include a waffle like grid design and/or fins. Such design variation may be useful in some embodiments for holding manufactured and/or natural bait to the float 100.

With continued reference to FIG. 1, one or more holes such as micro-holes, e.g., 112(1)-112(5), may be disposed through portions of the float 100. Suitable holes 112(1)-112(5) can be used for various purposes including but not limited to (i) releasing gas pressure generated during manufacturing of a float with certain materials, e.g., elastomeric materials, (ii) holding light sources such as light emitting diodes or fluorescent/luminescent gels and liquids, and/or (iii) holding scent materials such as releasable fishing oils/scents that are useful for attracting fish, e.g., molasses, etc.

In certain embodiments, as noted in FIG. 1 by the caption “Option 1”, holes 112(1)-112(5) may be located on the inner radial surface of a groove, e.g., a central groove such as groove 108(2), and orientated in a configuration approximately 90 degrees to a parting line (indicated as irregular line 111) produced from a molding process used to form the body of the float 100. Holes may also be located at other locations on the body of the float 100, for example, as shown in FIG. 1 by hole locations 114(1)-114(5) for the caption “Option 2” along a parting line 111, which can be formed by a molding process used for formation of the float 100.

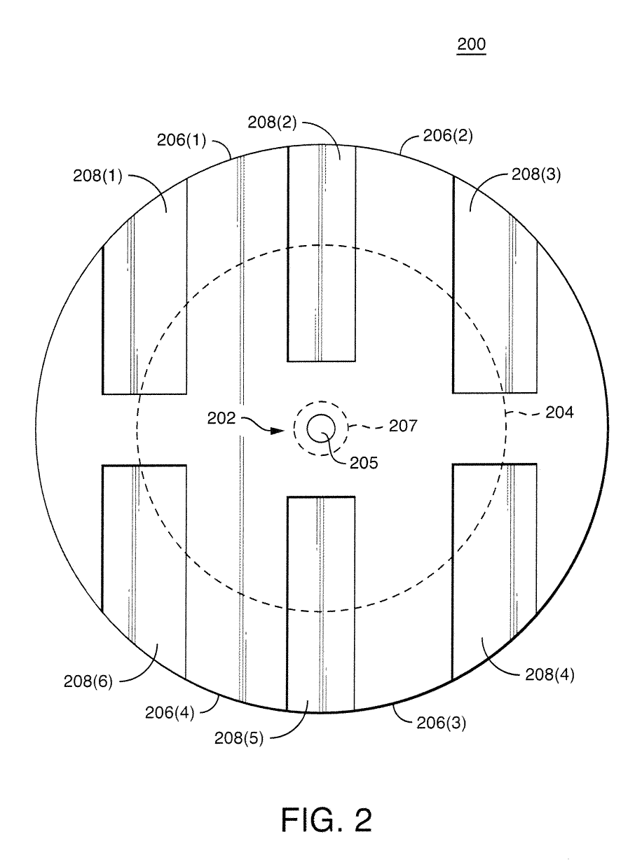

FIG. 2 is an end view depicting a further embodiment of a float 200 according to the present disclosure, similar to the one shown and described for FIG. 1, without through holes. Ribs 206(1)-206(4) are shown defined by grooves 208(1)-208(6). Bore 205 is shown passing along the longitudinal axis of the float 200 from end 202 to end 204 (shown in phantom).

Bore 205 may include one or more sections or portions, e.g., portion 207, that have different diameters, as shown in FIG. 2, and as shown and described in the Applicant's U.S. Pat. No. 4,477,996, the contents of which are incorporated herein by reference in their entirety. The sections of different diameters, e.g., 207, may be used for various purposes including to hold weights for adjusting the overall buoyancy of the float as desired. In exemplary embodiments, certain portions of bore 205 have a spherical configuration to hold a spherical lead weight at a desired location along the bore 205 within the float 200.

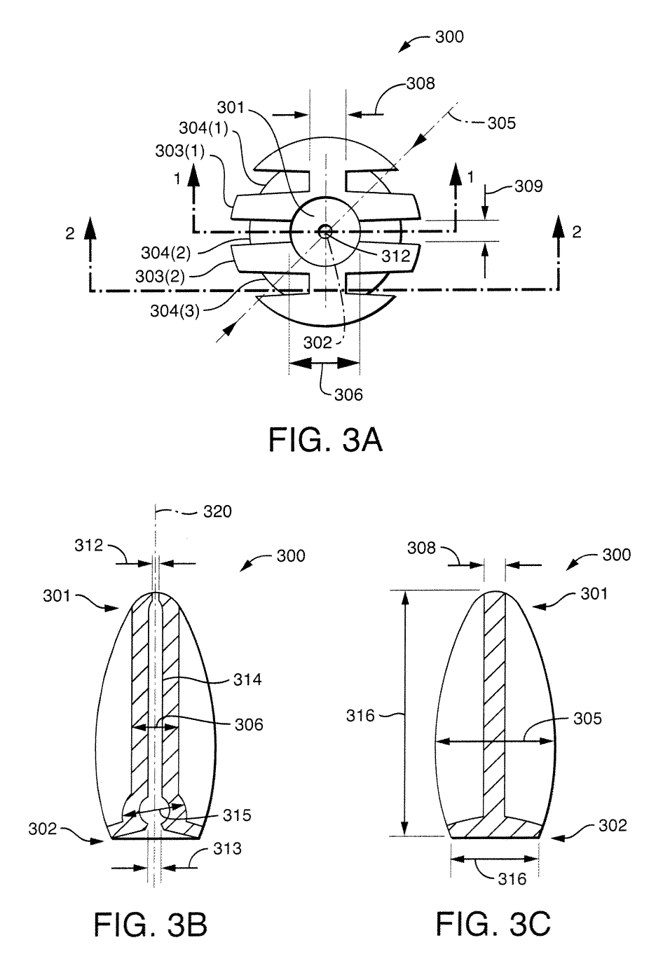

FIGS. 3A-3C depicts an end view and parallel cross sectional views of an exemplary embodiment of a float 300 according to the present disclosure. The end view depicted in FIG. 3A is towards a first end (or nose) 301 of float 300 and away from a second end 302. The float 300 includes a number of flutes or ribs 303(1)-303(2) separated by grooves 304(1)-304(3) oriented about a central portion (shown by diameter 306) along the longitudinal axis of the float 300. As shown, the ribs 303(1)-303(2) can be oriented parallel (or substantially parallel) to one another and may be offset by a desired distance 308 in exemplary embodiments.

With continued reference to FIG. 3A, the major diameter 305 and diameter 306 of a central portion are shown. The distance between flutes, e.g., the width of the grooves 309 and the diameter 312 of a first aperture at the first end 301 are indicated. The first aperture connects to a bore (not shown) to allow passing of fishing line. The thickness or web 308 between grooves can is also indicated and may be selected as desired. In the figure, cutting plane 1-1 is shown passing through the central groove 304(2) from one side of the float lateral surface to an opposite side. Cutting plane 2-2 is shown passing through groove 304(3), parallel to the longitudinal axis of the float.

FIG. 3B is a side cross-sectional view taken along cutting plane 1-1 in FIG. 3A. The diameter of the central portion 306 along with the diameter of the first aperture 312 at the first end 301 and that of the second aperture 313 at the second end 302. The first aperture 312 and the second aperture 313 are connected by central bore 314, which is configured to allow passage of fishing line through the float 300. Central bore 314 can include a pocket 315 (diameter indicated), e.g., spherical void, to allow placement of a weight (ballast) within the float 300. FIG. 3B also indicates the longitudinal axis 320 of float 300.

FIG. 3C is a side cross-sectional view taken along cutting plane 2-2 in FIG. 3A. Height 316 is indicated. Also shown, is thickness of the web 308, or distance between in line grooves. The corresponding thickness 316 of the second end 302 along cutting plane 2-2 is also shown.

As noted previously, any suitable material can be used for a float according to the present disclosure, e.g., float 300 of FIGS. 3A-3C. For example, the float material(s) may have any desired color and/or degree of transparency/translucence and/or opacity and/or specific gravity etc. In exemplary embodiments, an elastomeric material may be used for the float body to provide a desired degree of elasticity for the float. Also, one or more light sources can be incorporated or disposed within the float. Suitable light sources can include but are not limited light emitting diodes (LEDs), fluorescent and/or phosphorescent and other light emitting chemicals, etc. The one or more lights sources (e.g., LEDs) may be located within the one or more micro-holes, when present, and one or more appropriate suitable power sources may be disposed within the float to power the light source(s).

In exemplary embodiments, an elastomeric material available from Shell Oil Corporation that has the ability to expand to about 28 times its length and having a specific gravity of at or about 0.95 may be used. By having a specific gravity close to 1 (i.e., the specific gravity of water), the float can be well-suited to floating with the water current, giving a natural so-called “presentation” to game fish, and thus acting like natural bait. Exemplary suitable materials for the floats can include elastomers marketed under the registered trademark EMPILON as made available by the Ho Tai Industrial Co., Ltd. of Taiwan No. 72-9, Sec. 2, Jen-Ai Road Taipei, Taiwan.

In an exemplary embodiment, the float shown in FIGS. 3A-3C can be made of EMPILON elastomer and configured as a ¼ oz. weight such as for fresh-water fishing with a major diameter of 22.73 mm and height of 47.53 mm. For such, the diameter of the central portion can be 8.78 mm. The distance between flutes, e.g., the width of the grooves, can be 2.58 mm. The diameter of the first aperture at the first end can be 1.30 mm and the diameter of the second aperture at the second end can be 3.0 mm. The thickness or web between grooves can be 4.13 mm and the corresponding thickness of the second end in line with the grooves can be 16.54 mm. In such an embodiment, the diameter of the space or void for holding a lead weight can be 6.0 mm. Of course, it will be understood that the noted dimensions may be altered as desired and may be scaled up or down. For example, larger floats (e.g., 1, 2, and 3-oz, etc.) may be designed and used for salt-water applications.

Accordingly, embodiments of the present disclosure are directed to and can provide apparatus that substantially or altogether eliminate the shortcomings, limitations and disadvantages of the prior art by providing a fishing device, e.g., a float, with flutes or ribs. The ribs may be configured to increase stability of the float in the water. Such ribs may, in exemplary embodiments, be generally aligned along a portion of the longitudinal axis of the float, though other configurations and variations of the ribs are within the scope of the present disclosure. The fluted ribs can be molded into the body of the float, in exemplary embodiments. In operation, the ribs can add or increase stability to the float, which helps the float track better and which improves its use when used in fast moving water, e.g., during trolling. Such fluted ribs can also reduce the tendency of the float to spin in fast moving water.

Additionally, bait can be added to the grooves created by the fluted ribs. The fluted ribs can hold bait (acting as a flexible gripping surface) and allow a slow release of the bait scents. The flutes can also add volume to the float for a given weight or mass. The increased volume for a given weight or mass can improve the natural drifting of the float to better match the current speed or the surrounding water. This trait allows such floats to mimic bait fish and increase the chances of hooking and landing of a larger percentage of fish. The flutes can also provide improved the elastic qualities, e.g., “softness,” of the float , which in turn can help in when casting, e.g., when the float is cast into rocks, or when the float enters the water thereby reducing the resulting splash, etc. If a louder splash or popping action is desired the float can be fished in the opposite direction, as the concave face of the float will produce this action. This reverse orientation can attract fish feeding on or near the water surface.

While certain embodiments have been described herein, others may be practiced within the scope of the present disclosure. In exemplary embodiments, a float can include a textured surface or portion on the lateral surface (and/or for that matter either end). For example, the number and configuration of ribs used on a float according to the present disclosure may differ from the embodiments shown and described for FIGS. 1-3C. 24. Such as textured portion can be disposed on a rib and/or in a groove of the float. The textured portion in exemplary embodiments can include a grid or grid pattern and/or one or more fins.

As an example or such a textured surface, fluted ribs (or similar structures) may be oriented in a radial configuration along radii of the a cross section of the float in substitution for or addition to configurations where the ribs are more or less parallel to one another as shown in FIGS. 1-3C. Further, the orientation of one or more of the ribs can vary along the length or one or more sections/portions of the float. For illustration, a pair of ribs could be radially configured along part of the float and then be configured in parallel (e.g., as depicted in FIG. 2) along a different portion of the float or the ribs may individually or collectively present curves or different color combinations. Moreover, different materials, e.g., suitable plastics, can be used for various portions of a float.

It will be understood by one skilled in the art that the methods, systems, and apparatus of the present disclosure may be embodied in other specific forms without departing from the spirit thereof. The present embodiments are therefore to be considered in all respects as illustrative and not restrictive, and Applicant intends to claim all changes that come within the meaning and range of equivalency of the embodiments described herein.

What is claimed is:

1. A float comprising:
a body having a first end and a second end, a lateral surface, and a longitudinal axis, wherein a bore is disposed within the body and connects a first aperture at the first end with a second aperture at the second end; and
a plurality of ribs disposed on the body for stability of the float in water.

2. The float of claim 1, wherein the bore includes a spherical chamber configured and arranged to hold a weight.

3. The float of claim 1, wherein the plurality of ribs are separated by a plurality of grooves.

4. The float of claim 1, wherein the plurality of ribs comprises four ribs.

5. The float of claim 4, wherein the four ribs comprise two pairs of ribs on opposite sides of the float.

6. The float of claim 5, wherein each rib of the two pairs is in line with a corresponding rib on the opposite side of the float.

7. The float of claim 1, wherein the plurality of ribs comprises pairs of ribs on opposite sides of the float.

8. The float of claim 1, wherein the float has a cross-section shaped as an ogive.

9. The float of claim 1, further comprising a central channel disposed between ribs on opposite sides of the float.

10. The float of claim 9, further comprising one or more holes disposed in the float between opposing portions of the central channel.

11. The float of claim 1, further comprising one or more holes disposed in the float between opposing portions of the lateral surface.

12. The float of claim 9, wherein the one or more holes comprise five holes.

13. The float of claim 11, wherein the one or more holes comprise five holes.

14. The float of claim 3, further comprising one or more weights disposed within the plurality of grooves.

15. The float of claim 11, further comprising one or more weights disposed in the one or more holes.

16. The float of claim 1, further comprising a scent containing substance disposed within the float.

17. The float of claim 11, further comprising a scent containing substance disposed within the float one or more holes.

18. The float of claim 1, further comprising a scent containing substance disposed within the float.

19. The float of claim 11, further comprising a scent containing substance disposed within the float one or more holes.

20. The float of claim 1, further comprising one or more light sources disposed within the float.

21. The float of claim 11, further comprising one or more light sources disposed within the one or more holes.

22. The float of claim 20, wherein the one or more light sources include one or more light emitting diodes.

23. The float of claim 21, wherein the one or more light sources include one or more light emitting diodes.

24. The float of claim 22, further comprising a battery disposed within the float and configured and arranged to provide power to the one or more light emitting diodes.

25. The float of claim 23, further comprising a battery disposed within the float and configured and arranged to provide power to the one or more light emitting diodes.

26. The float of claim 1, wherein the lateral surface includes a textured portion.

27. The float of claim 26, wherein the textured portion is disposed on a rib.

28. The float of claim 26, wherein the textured portion is disposed in a groove.

29. The float of claim 26, wherein the textured portion comprises a grid.

30. The float of claim 26, wherein the textured portion comprises a fin.

31. The float of claim 1, wherein the body comprises an elastomer.
